(19) United States
(12) Patent Application Publication
(10) Pub. No.: US 2022/0131998 A1
(43) Pub. Date: Apr. 28, 2022

(54) COLOR PREDICTION

(71) Applicant: Hewlett-Packard Development Company, L.P., Spring, TX (US)

(72) Inventors: Peter Morovic, Sant Cugat del Valles (ES); Jan Morovic, London (GB); Sergio Etchebehere Juan, Sant Cugat del Valles (ES); Tanausu Ramirez Garcia, Sant Cugat del Valles (ES); Hector Gomez Minano, Sant Cugat del Valles (ES)

(73) Assignee: Hewlett-Packard Development Company, L.P., Spring, TX (US)

(21) Appl. No.: 17/419,390

(22) PCT Filed: Jul. 15, 2019
(86) PCT No.: PCT/US2019/041878

§ 371 Date: Jun. 29, 2021

(51) Int. Cl. H04N 1/60; G06K 9/62; G06N 20/20

(52) U.S. Cl. CPC H04N 1/60; G06N 20/20; G06K 9/6235

(57) ABSTRACT

Certain examples relate to a method of color prediction. Data indicative of color characteristics measured from a number of color test patches is obtained. Data indicative of combinations of color resources used to render the color test patches on a color rendering device is obtained. A first predictive model is trained using the data indicative of the combinations of color resources as an input and corresponding data indicative of color characteristics as ground truth outputs. A second predictive model is trained using the output data from the first predictive model as an input and the corresponding data indicative of color characteristics as ground truth outputs. A progressive mapping is implemented by the first and second predictive models to predict color characteristics rendered by the color rendering device given a combination of color resources.

### BACKGROUND

It is an object of color rendering devices to match rendered color outputs with defined input colors. This matching is performed while working within the constraints of the physical hardware, the software used and the color resources available to the color rendering devices. A color rendering device may be calibrated to some extent by measuring a limited number of rendered color outputs and comparing these with an input color. However, it is difficult to determine how an input color may map to a rendered color for the potentially millions of possible input colors and the large number of combinations of color resources that might be used by a color rendering device.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic illustration of an apparatus for color prediction according to an example;

FIG. 2 is a schematic illustration of a color rendering system which comprises a color prediction apparatus according to an example;

FIG. 3 is a schematic illustration showing a system for generating a color prediction according to an example;

FIG. 4 is a schematic illustration of a non-transitory computer-readable storage medium according to an example; and

FIG. 5 is a flow chart showing a method of training a predictive model according to an example.

### DETAILED DESCRIPTION

Color can be represented within imaging devices such as print and display devices in a variety of ways. For example, in one case, a color as observed visually by an observer is defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of one or more people. These categories can then be modelled using a lower number of variables.

Within this context, a color model may define a color space. A color space in this sense may be defined as a multi-dimensional space, with a point in the multi-dimensional space representing a color value and dimensions of the space representing variables within the color model. For example, in a Red, Green, Blue (RGB) color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. Other color spaces include: a Cyan, Magenta, Yellow and Black (CMYK) color space, in which four variables are used in a subtractive color model to represent different quantities of colorant or printing fluid, e.g. for a printing system; the International Commission on Illumination (CIE) 1931 XYZ color space, in which three variables (X, Y and Z or tristimulus values) are used to model a color; the CIE 1976 (L*, a*, b* —CIELAB or ‘LAB’) color space, in which three variables represent lightness (L*) and opposing color dimensions (a* and b*); the YUV color space, in which three variables represent the luminance (Y) and two chrominance dimensions (U and V); and the IPT color space, in which the three variables represent a lightness or Intensity dimension (I), a “Protanopia” red-green chroma dimension (P), and a “Tritanopia” yellow-blue chroma dimension (T).

Other color spaces include area coverage spaces, such as the Neugebauer Primary area coverage (NPac) color space. An NPac vector in the NPac color space represents a statistical distribution of Neugebauer Primaries (NPs) over an area of a halftone. In a simple binary (bi-level, i.e. two drop states: “drop” or “no drop”) printer, an NP may be one of 2^{k}−1 combinations of k printing fluids within the printing system, or an absence of printing fluid (resulting in 2^{k} NPs in total). An NP may thus be seen as a possible output state for a print-resolution area. The set of NPs may depend on an operating configuration of a device, such as a set of available colorants. A colorant or printing fluid combination as described herein may be formed of one or multiple colorants or printing fluids. For example, if a bi-level printing device uses CMY printing fluids there can be eight NPs or output states. These NPs relate to the following: C, M, Y, CM, CY, MY, CMY, and W (white or blank indicating an absence of printing fluid). An NP may comprise an overprint of a plurality of available printing fluids, such as a drop of magenta on a drop of cyan (for a bi-level printer) in a common addressable print area (e.g. a printable “pixel”). An NP may be referred to as a “pixel state”.

In multi-level printers, e.g. where print heads are able to deposit N drop levels, an NP may include one of N^{k}−1 combinations of k printing fluids, or an absence of printing fluid (resulting in N^{k} NPs in total). A multi-level printer may use a piezo-electric or thermal print head that is capable of depositing different numbers of drops or different drop volumes, and/or may use multiple passes of a print head, to enact different drop states. For example, if a multi-level printer uses CMY printing fluids with four different drop states (“no drop”, “one drop”, “two drops” or “three drops”), available NPs can include C, CM, CMM, CMMM, etc. A “drop sequence” as used herein may define a set of drop states used or useable by a given printing system in a given operating state.

An NPac space provides a large number of metamers. Metamerism is the existence of a multitude of combinations of reflectance and emission properties that result in the same perceived color for a fixed illuminant and observer. Multiple NPac vectors in an NPac space may have a similar colorimetry (e.g. a similar representation in a color space with three dimensions). Several NPac vectors may thus be useable to represent a given color. Different NPac vectors that have similar colorimetry may, however, have differing attributes or properties other than colorimetry (e.g. different appearances under different illuminants).

Each NPac vector may therefore define a probability distribution for colorant or printing fluid combinations for each pixel in the halftone (e.g. a likelihood that a particular colorant or printing fluid combination or available output state is to be placed or defined at each pixel location in the halftone). In this manner, a given NPac vector defines a set of halftone parameters that can be used in the halftoning process to map a color to NPs to be statistically distributed over the plurality of pixels for a halftone. Moreover, the statistical distribution of NPs to pixels in the halftone serves to control the colorimetry and other print characteristics of the halftone.

Spatial distribution of NPs according to the probability distribution specified in the NPac vector may be performed using a halftone method. Examples of suitable halftoning methods include matrix-selector-based Parallel Random Area Weighted Area Coverage Selection (PARAWACS) techniques and techniques based on error diffusion. An example of a printing pipeline that uses area coverage representations for halftone generation is a Halftone Area Neugebauer Separation (HANS) pipeline.

A simple color space may be defined using ink vectors which represent the proportion of individual inks within a combination such as an NPac vector. For example, an ink vector may be a vector with a predefined set of elements, where each element represents an ink (e.g. a colorant or color output available to the rendering device) and the value of the element represents a quantity of ink (e.g. [C, M, Y, K]). An ink vector may be used to instruct deposit of inks in a printing device, e.g. where the value represents a particular number of drops or quantity of ink to deposit. An ink vector may be used to instruct the printing of a color in an addressable area of a substrate (e.g. a print “pixel”).

Certain examples described herein address a challenge of predicting color characteristics, such as spectral reflectance of color rendered by a color rendering device, based on data indicative of combinations of color resources, such as available colorants represented by ink-vectors and/or NPacs. These examples may be used in a number of ways. For example, they may be used to determine the most ink-efficient combination of color resources to use for rendering a particular color, to determine a combination of available color resources which comes closest to rendering the desired input color, to define a color gamut of a printer having predetermined color resources, and/or to pre-filter millions of possible NPacs (statistical distributions of inks over a halftone pattern) or ink-vectors (proportions of individual inks in a combination) to a more manageable number before physical testing and measuring of rendered color patches for calibration.

Certain examples described herein make use of parameter values generated by training predictive models on training samples. These parameter values may parameterize predictive models that enable an output of the color rendering device to be predicted. The predictive models may be applied to an input array of values to generate an output array of values. In this case, the parameter values may comprise values for weights and/or biases that are applied to the input array, e.g. as one or more functions, to generate the output array. The predictive models may comprise probabilistic models (such as Bayesian models or Gaussian processes), logistic models and/or neural network models. The predictive models may be linear or non-linear. In one case, the one or more functions may be arranged as one or more “layers” that are applied to the input array and that are separated by one or more non-linear functions. The parameter values may be generated by training the predictive models using training samples generated from measurement of a rendered color output with spectral measurement devices.

Certain examples use two (or more) predictive models where the first predictive model is trained using data indicative of the combinations of color resources as an input and data indicative of measured color characteristics of the rendered output colors as ground truth data. The predicted color characteristics or outputs from the first predictive model are used as inputs for the second predictive model which also uses the data indicative of measured color characteristics as ground truth data. The outputs from the second predictive model may then be used as inputs in a next iteration of training of the second predictive model. Further training iterations may be performed to further improve accuracy. Subsequent predictive models may also be added. Although the predictive models can be thought of as a single model with multiple parts, using a second (and subsequent) parts significantly improves the accuracy of the prediction compared with just training a single model or part.

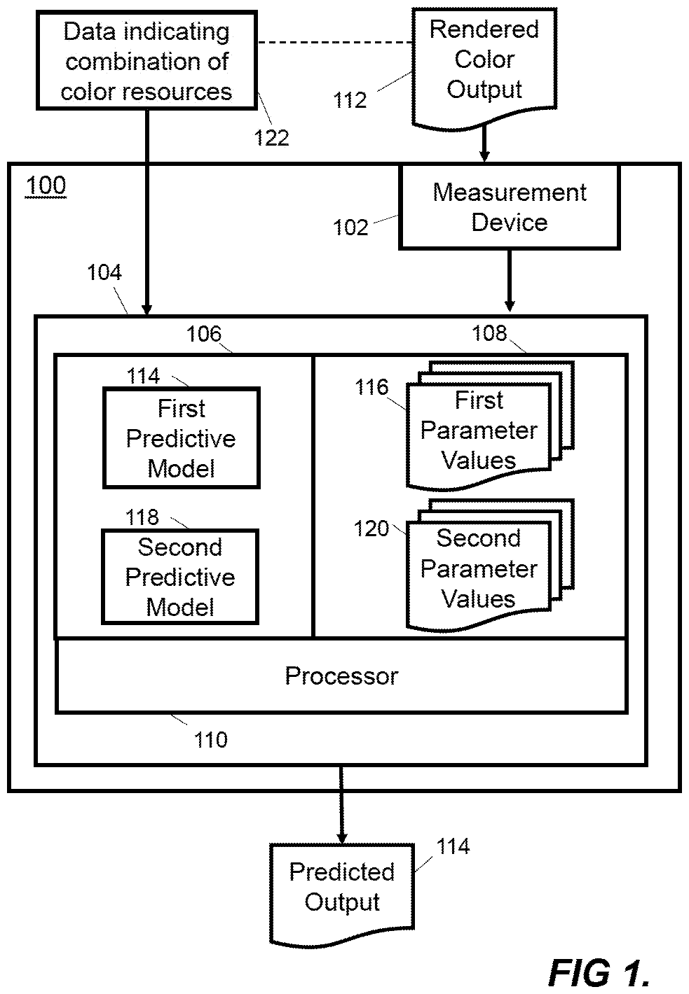

FIG. 1 shows an apparatus for color prediction 100 according to an example. The apparatus 100 comprises a measurement device 102 to measure data indicative of color characteristics of a rendered color output 112. The measurement device 102 may be a spectral measurement device, such as any type of spectroscopic sensor which is capable of measuring a spectral characteristic, e.g. a spectral property over a range of wavelengths. The spectral property may be a detected emittance and/or reflectance value. A measurement device may be called a sensor, a tool, a detector, or any equivalent term. In some examples, a spectral measurement device 102 is configured to measure a spectral property of a rendered color output 112 in a visible range, e.g. between 400 nm and 700 nm. The spectral measurement device 102 may output an array of values having a spectral resolution, e.g. covering the range 400-700 nm in 20 nm intervals, such that the array of measured values has 15 entries. A spectral characteristic to be measured may be defined based on a number including: a range of wavelengths over which the spectral response is measured; a wavelength interval between sequential measurements (i.e. an output resolution); the spectral property being measured; and/or a technique or detector type used in the spectral measurements. A spectral measurement technique or detector type that defines a spectral characteristic may further be characterized by: a set of applied filters; an application of illumination to a target of the measurement; a type of sensor used; an inclusion of a set of optical elements within the spectral measurement device; and/or any other controlled variable that may affect the result of the measurement of the spectral measurement device.

In an alternative example, the measurement device 102 may be a sensor to measure colorimetry color characteristics such as a tristimulus colorimeter for measuring International Commission on Illumination (CIE) 1931 XYZ color space tristimulus values, a spectroradiometer or a spectrophotometer for example. The measurement device may be integrated with the color prediction apparatus 100. In certain cases, the measurement device 102 may be omitted or located remotely, such that the apparatus 100 obtains measurement data indirectly.

The rendered color output 112 comprises a number of color test patches which are measurable using spectral analysis. In some examples, the rendered color output 112 represents an output from a color rendering device, where the rendered color output 112 comprises colors which are to be measured by the color measurement apparatus 100. The color test patches may be rendered by the color rendering device using a combination of color resources such as inks and substrates, e.g. by printing a square of a defined color over a plurality of print resolution pixels. The rendered color output 112 may be an output from a printing process or system for example, an inkjet printer, an electrophotographic printer, a color-capable 3D printer, and/or a textile printing process. In other examples, a rendered color output 112 may comprise an image formed on a screen or monitor.

In the example of FIG. 1, the color prediction apparatus 100 comprises a prediction engine 104 for the color rendering device. The prediction engine 104 is configured to receive data 122 indicative of a combination of color resources used by the color rendering device and to generate a prediction of the color characteristics of a color rendered by the color rendering device using the combination of color resources. The prediction of the color characteristics may, for example, be a predicted spectral measurement, e.g. as would be measured by the measurement device 102.

The prediction engine 104 comprises a first storage medium 106 storing computer program code to implement a first predictive model 114 and a second predictive model 118. In examples where the prediction engine 104 receives unprocessed electrical signals from the measurement device 102, the prediction engine 104 may process these before application of the predictive models 114 and 118. The processing of these electrical signals may involve converting the signals into numeric values and storing these values in a data structure such as an array. The prediction engine 104 may perform pre-processing of data before, and/or post-processing of data after, the application of the predictive models 114 and 118 to the output of the measurement device 102. Processing of data may be for example, normalization, factorization, conversion of data storage types from, or to, arrays, or any other function so that the predictive model can be applied.

The prediction engine 104 may be implemented as any combination of hardware and programming configured to perform the functionality described herein. A storage medium may be a non-transitory computer-readable storage medium for example, a hard drive, a CD-ROM disc, a USB-drive, a solid-state drive or any other form of magnetic storage device, optical storage device, or flash memory device, maintained locally or accessed remotely, capable of having thereon computer readable code suitable for the function described herein.

The first predictive model 114 receives, as an input, data indicative of combinations of color resources 122 to be used in a color rendering device. This data may be in the form of ink vectors or NPac vectors. The first predictive model 114 maps this data to an output which may be considered a first approximation prediction of a measured spectral reflectance, e.g. in the form of an array of values corresponding to predicted amplitudes for a range of wavelengths. In one case, each element in the array of values may relate to a given subrange or bin of wavelength values, and the value of the element relates to a combined emittance or reflectance for this subrange or bin.

In one case, the predictive model 114 may generate an output array by implementing a machine learning architecture. This may be, for example, an architecture comprising one or more of: support vector machines, linear regression, polynomial regression, neural networks or any other techniques suitable for use in a supervised learning environment. The predictive model 114 may be implemented in a high-level programming language for example, Java, C++, Python, Scala, or any other suitable language. The predictive model 114 may be implemented via a defined architecture, e.g. in computer program code that uses functions implemented in a machine learning library, e.g. a library of computer program code. In an example, the predictive model implements polynomial regression with second-order cross terms and weight decaying for example using a regularization terms such as Tikhonovs constraint on a norm.

The second predictive model 118 maps the output from the first predictive model 114 to an improved prediction of color characteristics (e.g. from an initial prediction of spectral reflectance to a refined prediction of spectral reflectance for the combination of color resources). The input array of values may be the output array of wavelengths from the first predictive model 114 and the output from the second predictive model may also comprise an array of predicted wavelengths. The second predictive model 118 may generate an output array by implementing a machine learning architecture in a similar manner to the first predictive model 114 as described above. The second predictive model 118 may be modelled as an independent data processing system and/or comprise a different instantiation of a class or computer program code object within a common machine learning library. In an example, the second predictive model 118 also implements polynomial regression with second order cross terms and weight decaying for example using a regularization terms such as Tikhonovs constraint on a norm. For example, the second predictive model 118 may comprise a different instance of the model used for the first predictive model 114, e.g. that is configured to receive a different input array format and have different parameter values.

In the example of FIG. 1, the prediction engine 104 comprises a second storage medium 108 storing first parameter values 116 and second parameter values 120. The parameter values 116 and 120 are generated by training the predictive models 114 and 118 on a set of training samples as described in more detail below. Each training sample relates to measurement of test patches from a rendered color output 112 rendered by a particular color rendering device using a predetermined combination of color resources and comprises data indicative of color characteristics of the test patches measured using the measurement device 102 and data indicative of a combination of color resources used to render the test patches by the color rendering device.

In the example of FIG. 1, the prediction engine 104 comprises a processor 110 to execute the computer program code of the predictive models 114 and 118 as stored within the first storage medium 106 to implement the predictive models 114 and 118, where the predictive models are parameterized with respective parameter values 116 and 120 from the second storage medium 108. In use, the execution of the computer program code by the processor 110, applies the predictive models 114 and 118 to data indicative of a combination of color resources 122 to generate a predicted output 114 of color characteristics rendered by the color rendering device using the combination of color resources. The processor 100 may be a standard central or graphical processing unit (CPU or GPU), or a custom processing unit designed for the purposes described herein, or any other type of processor which is capable of performing the functions described herein. In certain cases, multiple processors may be provided, wherein each processor may have multiple processing cores. Although the first storage medium 106 and the second storage medium 108 are shown separately in FIG. 1, in certain cases, they may comprise different portions of a common or shared storage medium.

The apparatus for color prediction 100 shown in FIG. 1 may be used in color rendering systems. Color rendering systems may be two-dimensional or three-dimensional printing systems which produce outputs comprising at least one color. Alternatively, a color rendering system may be a manufacturing system producing objects with defined colors, or a monitor to display images or videos. Color rendering systems may comprise a color rendering device and a combination of external hardware and program code which may be used to calibrate the color rendering device. In one case, the data indicating a combination of color resources may comprise an CMYK ink vector or an RGB display pixel value. In this case, the predicted output 114 may comprise a predicted spectral response for a printed image or display screen. The predicted output 114 may be used prior to actual rendering to ensure that the color rendering is suitable, e.g. as characterized by the predicted spectral response.

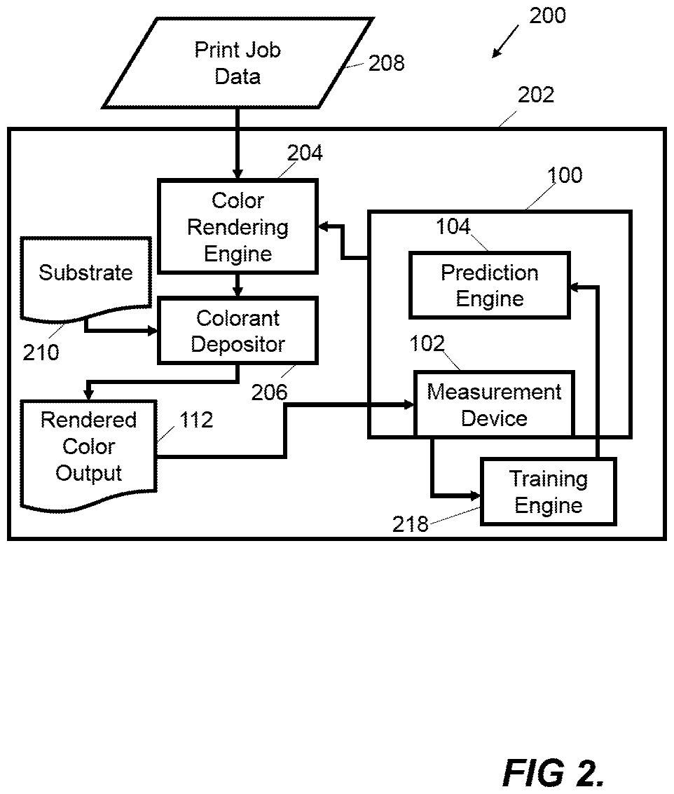

An implementation of an apparatus for color prediction 100, according to examples, in a color rendering system is shown in FIG. 2. The example of FIG. 2 shows how the apparatus 100 may be used in a color rendering system 200, and also shows how the prediction engine 104 may be configured with appropriate training data. It should be noted that certain components of FIG. 2 may be omitted for certain implementations, e.g. the components used to train the prediction engine 104 may be used in a laboratory setting and an on-site color rendering system 200 may not include these components.

According to the example of FIG. 2, the color rendering system 200 has a color rendering device 202. The color rendering device 202 may be a color printer. The color printer may be two or three-dimensional. A color rendering engine 204 of the color rendering device 202 receives print job data 208 and generates instructions for a colorant depositor 206 to produce a rendered color output 112 by depositing colorant onto a substrate 210. Print job data 208 is data indicative of a print job which may comprise image data encoded with color information for rendering the image by the color rendering device 202. The print job data 208 may be input to the color rendering device 202 via an external computer or input directly at a user interface of the color rendering device. The substrate 210 may be any material which may receive a colorant such as, paper, polymers, fabrics, or any other suitable materials.

In some implementations, the color rendering engine 204 accesses color definitions, stored on a computer-readable storage medium, which maps the color information of the print job data 208 to quantities of colorants available to the colorant depositor 206. The color definitions may be used to generate instructions for the colorant depositor 206, so as to deposit colorant to create a rendered color output 112 according to the print job data 208. The color definitions may be stored within the color rendering engine 204 or may be stored externally to the color rendering engine 204. The color rendering engine 204 may be any combination of hardware and computer program code configured to perform the function described herein. For example, the color rendering engine 204 may comprise an embedded processor of a printer. The colorant depositor 206 may comprise a printing device configured to receive instructions from the color rendering engine 204 and deposit one or more colorants onto the substrate 210 to generate the rendered color output 112. In a color printing system, the colorant depositor 206 may comprise a print head comprising ink-depositing nozzles to direct ink onto the substrate 210 at predetermined positions and in predetermined quantities. In other examples of color rendering devices, a colorant may be a dye, a pigment, an ink, a combination of inks, a light source, or any material or agent which has a defined color and may be used alone or in combination with other colorants to produce a color to be measured by the primary spectral measurement device 102.

The color prediction apparatus 100 may comprise a prediction engine 104 and measurement device 102 as previously described. In certain cases, the measurement device 102 may be located externally to the color prediction apparatus 100, such that said apparatus receives data indicative of color measurements. The prediction engine 104 comprises first and second trained predictive models 114 and 118 with corresponding parameter data 116 and 120 as previously described. These may be used to predict color characteristics of the rendered color output 112 from the color rendering system 200, given data indicative of a combination of color resources. In this case, the combination of color resources may be derived from the print job data 208 and interpreted by the color rendering engine 204 to instruct the colorant depositor 206.

FIG. 2 also shows a training engine 218 that may be used to train the predictive models and derive parameter data based on the color rendering capabilities of the color rendering system 200. In a training configuration, the color rendering engine 204 receives print data 208 that instructs the rendering of a number of test patches. For example, print data 208 in this case may be data comprising image data comprising color information spanning a color gamut of the color rendering device 202 (or at least a desired sample of the color gamut). When rendered, the print data 208 may include a range of colors that the colorant depositor 206 is capable of producing on available substrates of the color rendering device 202.

When training the prediction engine 104, the color rendering engine 204 generates colorant depositor instructions based on the received print job data 208. The colorant depositor 206 generates a set of color test patches by depositing colorant onto a substrate 210 based on received colorant depositor instructions. A set of color test patches rendered on a substrate 210 may be called a rendered color test. The measurement device 102 measures color characteristics of the rendered color test and the data indicative of the color characteristics is sent to be used by a training engine 218 to train the predictive models 114 and 118. These color characteristics may be spectral measurements.

In training configurations, the training engine 218 generates a set of training samples by pairing, for the rendered color test, data indicative of combinations of color resources, such as ink vectors from the print job data 208 or color rendering engine 204, with color characteristics, such as measurements from the measurement device 102. For example, each test patch, rendered using a particular ink vector or NPac vector is paired with a measurement of the rendered version. The predictive models 114 and 118 of the prediction engine 104 are trained using the set of training samples, wherein data indicative of a combination of color resources is used as an input for the first predictive model 114 and data indicative of the color characteristics is used as a ground truth output for the first predictive model 114. The training model may generate parameter values which are accessed by the prediction engine 104 during a prediction to parameterize the predictive model 114.

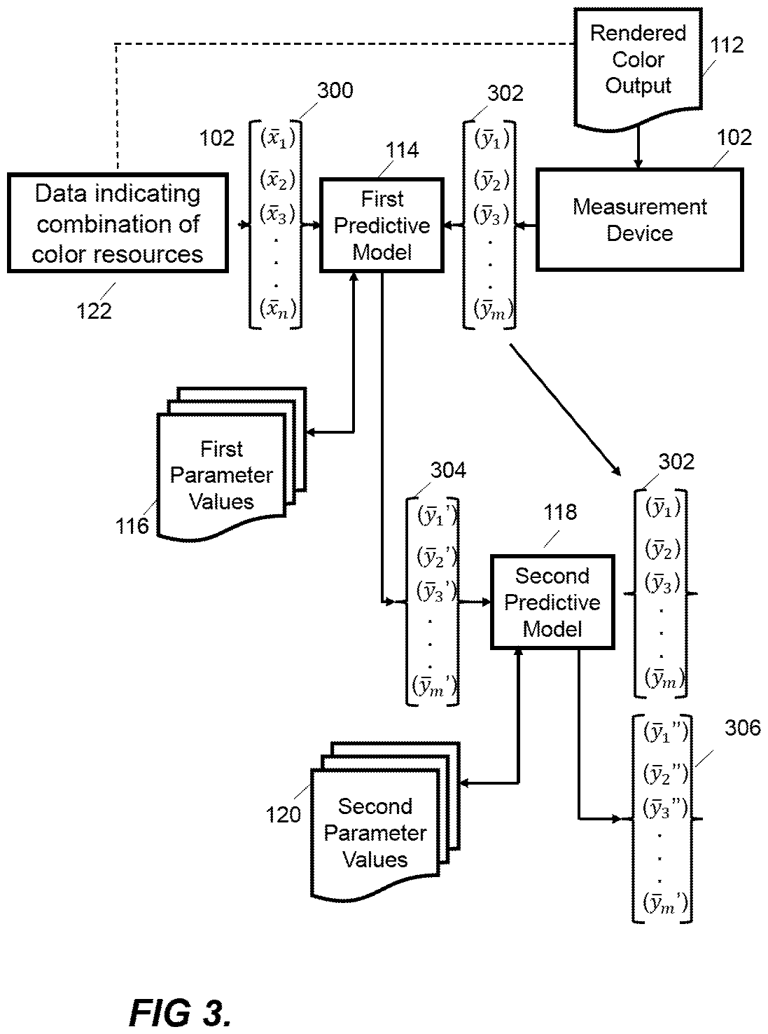

FIG. 3 shows a process that may be implemented by the training engine 218 to obtain the first and second parameters values 116 and 118 by training the first and second predictive models 114 and 116. Data indicating a combination of color resources 122 comprises ink vectors or NPac vectors used to generate test patches on the rendered color output 112. These data indicative of combinations of color resources can be represented by an array—X—of values 300 [x1, x2, x3 . . . xₙ], which may represent different proportions of inks for example (e.g. [30%, 100%, 30%, 0%] representing percentage of coverage of respective inks over an area or [1, 3, 1, 0] representing 1, 3, 1 and 0 drops of CMYK inks respectively). If the array X of values represents an NPac vector then the values may be normalized to sum to 1, where there are N^{k} elements for N drop states and k inks. The measurement device 102 also provides an array 302 —Y—of spectral reflectance value corresponding to the measured test patch. The values [y1, y2, y3, . . . yₘ] may correspond to proportions of different wavelengths measured by the device 102.

In one case, the first predictive model 114 may implement a second order polynomial f₁(x), although other functions may alternatively be used. In this case, the first parameters values 116 —T₁—may be determined by optimizing the equation or cost function—∥f₁(X)*T₁−Y∥, e.g. by minimizing the cost function. T₁ may be computed by determining a pseudo-inverse (e.g. a Moore-Penrose inverse) and may include a regularization term to constrain the condition number of T₁− in an example Tikhonov regularization may be used. In this case, f₁(X)*T₁ may provide an array 304 corresponding to a first approximation of spectral reflectance Y′, e.g. an array [y1′, y2′, y3′, . . . yₘ′]. In an example a second order polynomial is employed and only square terms or cross-product terms (or both) may be added. In some examples regularization is not used.

The second predictive model 118 may also implement a second order polynomial f₂(x). The second predictive model 118 may be the same second order polynomial function with different parameters, or a different function. Other functions may alternatively be used. The second predictive model 118 uses the first order prediction Y′ 304 as its input, whilst reusing the measured spectral reflectance Y 302 as ground truth values. The second parameter values 120 or T₂ are then solved such that the following equation or cost function is optimized, e.g. via minimization—∥f₂(Y′)*T₂−Y∥. T₂ may be computed by determining a pseudo-inverse (e.g. a Moore-Penrose inverse) and may include a regularization term to constrain the condition number of T₂. Now, f₂(Y′)*T₂ provides a second approximation of spectral reflectance Y″—[y₁″, y₂″, y₃″ . . . yₘ″]—306 which is an improved prediction of the measured spectral reflectance Y 302.

The second predictive model 118 may be further trained to improve the prediction of spectral reflectance or other color characteristics given data indicative of a combination of color resources. For example, the prediction Y″ 306 from the above training may be taken as an input in a new iteration of training and the equation ∥f₃(Y″)*T₃−Y∥ minimized. Further training steps like this may be repeated to get more and more accurate predictions but further optimizing the second parameter values (T₁, T₂, T₃ . . . ). This iterative application provides a progressive mapping.

Table 1 below shows experimental results for 15K samples for a 9-ink system where 2895 samples were used as the training set and the remaining 11577 samples were used for testing. The first column shows results from the first predictive model 114 and parameters T₁ only, the middle column shows the additional of the second predictive model 118 and parameters T₂, and the third column shows results after adding a third predictive model with a corresponding third set of parameters T₃.

TABLE 1

| DIRECT (training) | 2STEP (training): | 3STEP (training): |
|---|---|---|
| median: 9.635 | median: 2.875 | median: 1.328 |
| stddev: 12.263 | stddev: 6.474 | stddev: 3.098 |
| pctI95: 39.828 | pctI95: 20.820 | pctI95: 9.715 |
| DIRECT (testing) | 2STEP (testing): | 3STEP (testing): |
| median: 9.675 | median: 2.958 | median: 1.340 |
| stddev: 12.397 | stddev: 6.632 | stddev: 3.309 |
| pctI95: 40.573 | pctI95: 20.665 | pctI95: 9.846 |

The results show errors between the predictions and the measures spectral reflectance during training and testing and include the median error, the standard deviation, the 95% percentile (pctI95). As can be seen, these statistics improve with every iteration.

The training of the predictive model 114 may be implemented in any combination of hardware or computer program code. Some or all of the training engine 218 functionality may be performed by one or more parts of the color rendering system 200 for example, the prediction engine 104, or this may be provided by a separate component. In one case, components 212 to 218 are not provided with the color rendering system 202. In this case, training may occur at a remote site and parameter values generated during training may be supplied to multiple on-site implementations of the color rendering system 202. In another case, the components 212 to 218 may be provided and utilized during an installation of the color rendering system 202, such that for subsequent operation these components are not present.

Returning to FIG. 2, in this example, the predicted color characteristics from the prediction engine 104 are received by the color rendering engine 204. The color rendering engine 204 may use the predicted output 114 to calibrate or update the color definitions.

The rendered color output 112 measured by the measurement device 102, used to generate parameter values 116 and 120 by training the predictive models 114 and 118, may be a rendered color output 112 which is not a rendered color test. Any rendered color output 112 may be used to generate a training sample. However, it may be advantageous to use a rendered color test generated from test patch data as the test patch data may be designed to efficiently sample a color gamut which the color rendering device 202 is able to render.

The parameterized models may be continuously updated with use of the color rendering apparatus 200. For example, a customer or user of the apparatus may determine a combination of colorants for a task and the newly printed color(s) may be measured and the data indicative of the combination of color resources used together with data indicative of measured color characteristics to further train the models. In other words, over time and use of the apparatus 200, additional samples may be used to update the training and improve the accuracy of color prediction.

Rendered color test patches may also be advantageous where the desired training data is of a subset of the full spectral data measured by the primary and ancillary spectral measurement devices. For example, using a rendered color output may be useful where the predictive models 114 and 118 are used to predict spectral features in a narrow range of a full wavelength range measurable by the measurement device 102, for example by segmenting the rendered colors into lighter and darker colors with separately trained predictive models 114 and 118 for respective segmented colors. The rendered colors may alternatively be segmented by total ink-coverage. The ink-vectors may be grouped by how much ink they use (this may include taking into account which of the inks are being used).

As noted previously both ink vectors and NPac vectors can be used as data indicative of combinations of color resources. The relationship between ink-vectors and NPacs is a one-to-many relationship. Any given ink-vector can have many (in fact infinitely many) possible NPacs that match the ink-vector but vary in NPac composition. A print pixel can be instructed/defined in ink-vector terms (in which case it must be followed by an ink-vector based halftoning approach that processes each ink-layer separately) or in NPacs terms (in which case it must be followed by an NPac based halftoning approach that only distributes the NPacs spatially and does so in one go). Ink-vectors are far less descriptive (since how the inks are combined is left up to halftoning) of the printed output than NPacs (which fully determine the halftone's statistics even before halftoning), however the example is still able to provide accurate color characteristics predictions based on ink vectors.

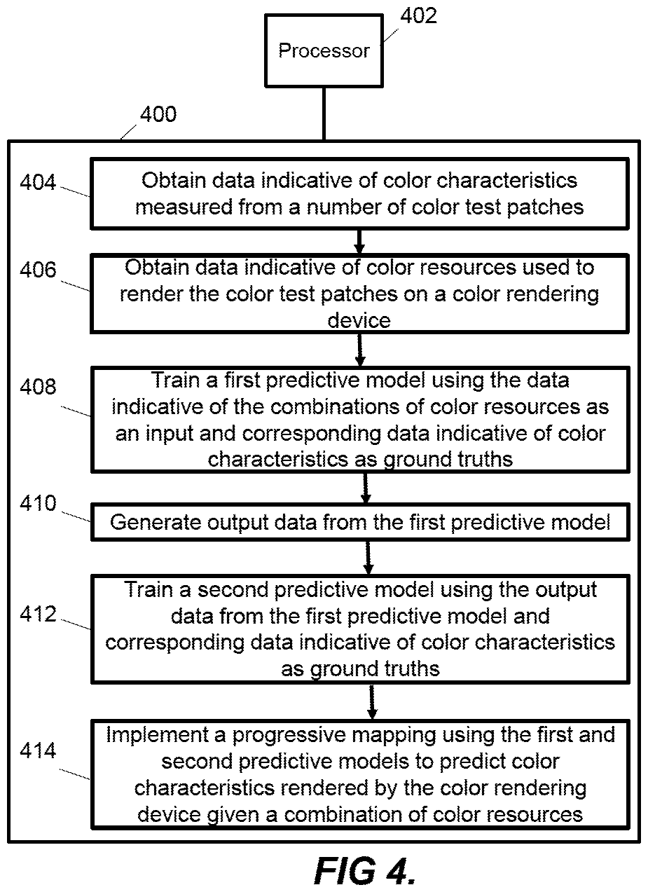

Figure shows a schematic illustration of a non-transitory computer readable storage medium 400 according to an example. The storage medium 400 stores instructions which when executed by a processor 402 cause the processor to perform the blocks of FIG. 4. At block 404, the processor obtains data indicative of color characteristics measured from a number of color test patches. The characteristics may be a spectral reflectance measured using a spectral measuring device. At block 406, the processor obtains data indicative of color resources used to render the color test patches on a color rendering device, for example ink vectors or NPac vectors related to the combination of inks used to render the color test patches.

At block 408, the processor trains a first predictive model using data indicative of the combinations of color resources as an input and corresponding data indicative of color characteristics as ground truth data. At block 408, the processor generates output data from the first predictive model which are first order predictions of the color characteristics of combinations of color resources used to render the color test patches. At block 412, the processor trains the second predictive model using the output data generated by the first predictive model and corresponding to predictions of the color characteristics as input, and corresponding data indicative of color characteristics as ground truth data. In this manner a progressive mapping or prediction is implemented. The use of a second predictive model improves the accuracy of the prediction and reduces the amount of training required, for example reducing the number of NPacs that have to be tested from millions to less than ten thousand whilst still providing an accurate prediction across the full range of colors reproducible by a color rendering device. This accuracy may be further improved by adding training iterations for the second predictive model 118 in which the output prediction from the first iteration 306 is used as an input in a next iteration, together with the same data indicative of color characteristics as ground truth outputs. Further iterations may be added to improve accuracy.

At block 414, the trained predictive models are used to implement a progressive mapping using the first and second predictive models to predict color characteristics rendered by the color rendering device given a combination of color resources, as indicated by data such as NPac vectors or ink vectors.

The examples can be used for ink vector as well as NPac vector based predictions which is useful as the ink space is significantly smaller than the NPac space—for example in a printer with 14 ink channels (9 inks with 5 dual drop weight) there are 268 million different NPac vectors and therefore being able to operate in ink space can significantly reduce computational and operator resources (e.g. an ink space vector may have 9 elements that may have discrete values based on the available drop weights).

The computer readable storage medium 400 according to the example of FIG. 4 may be part of the first storage medium 106 or the second storage medium 108 shown in the example of FIG. 1. Alternatively, the computer readable storage medium of FIG. 4 may be stored in a separate storage medium which may be part of the prediction engine 104 or another part of the color measurement apparatus 100 according to FIG. 1.

The computer readable storage medium 400, according to certain examples, may also store instructions that, when executed by the processor 402, cause the processor 402 to reconfigure a color rendering engine based on the predicted rendered color, for example by selecting a lower ink usage combination of color resources or ink which still reproduces the desired color. The color rendering engine may be a color rendering engine 204 such as that in FIG. 2. The color rendering engine may update color definitions based on the predictions of the prediction apparatus 100.

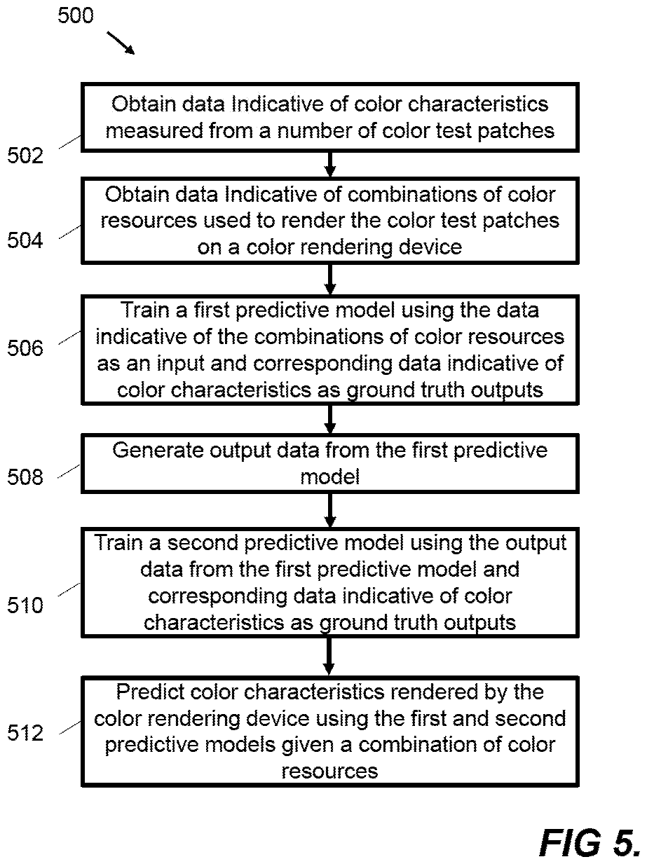

FIG. 5 shows a method 500 of training a predictive model which maps data indicative of a combination of color resources (such as ink vectors representing a combination of inks) for a color rendering device to a predicted color characteristic (such as spectral reflectance). The method 500 may be performed in association with apparatus 100 of FIG. 1 or elsewhere in a color rendering system 200 as shown in FIG. 2. The method may be performed to identify the most efficient combination of inks to reproduce a color, to determine where ink vectors lie in another color space, to pre-filter NPacs to reduce to a smaller number before physical testing and/or to determine the gamut of a color rendering device. The method 500 may be performed by an entity that is different to the entity that controls the apparatus 100 or the color rendering device 202, e.g. the apparatus 100 or the color rendering device 202 in other examples may be provided by pre-generated parameter values 116 and 120 without explicitly performing the method 500 themselves. Additionally, different parts of the method 500 may be performed by different components of a color rendering device or color measurement apparatus.

At a first block 502, the method 500 comprises obtaining data indicative of color characteristics measured from a number of color test patches, for example using a spectral measurement device, the color test patches having been rendered on a color rendering device. In certain cases, a tristimulus or colorimetric measurement may be made instead of, or as well as, a spectral measurement. In this case, an output array may have 3 values. In examples according to FIG. 2, the color test patches may be rendered in a color rendering device 202 by receiving test patch data 208, generating colorant depositor instructions and depositing colorant onto a substrate 210 based on the colorant depositor instructions. The data indicative of color characteristics may be processed or unprocessed data and may be in the form of an array of values. At a second block 504, the method 500 comprises obtaining data indicative of combinations of color resources used to render the color test patches on the color rendering device, for example ink vectors or NPac vectors.

At block 506, the method 500 comprises training a first predictive model using the data indicative of the combinations of color resources as an input and corresponding data indicative of color characteristics as ground truth outputs. Samples of corresponding pairs of the two data sets may be implemented in data structures which are suitable for training a predictive model. The predictive model may be configured by configuration parameters that specify a model architecture that is separate from the trained parameter values.

At block 508, the method 500 comprises generating output data from the first predictive model which corresponds with predictions of color characteristics given a combination of color resources.

At block 510, the method 500 comprises training a second predictive model using output data from the first predictive model as an input and corresponding data indicative of measured color characteristics as ground truth outputs. Samples of corresponding pairs of the two data sets may be implemented in data structures which are suitable for training a predictive model. The predictive model may be configured by configuration parameters that specify a model architecture that is separate from the trained parameter values.

The predictive models 114 and 118 together are trained to map the data indicative of combinations or color resources to measurements of color characteristic of those combinations when rendered on the color rendering device. The determined parameters of the predictive models, for example the coefficients of the respective second order polynomials, are then stored as respective first and second parameter values 116 and 120.

At block 512, the method 500 comprises predicting color characteristics of a color rendered by a color rendering device given a combination of color resources. This is achieved using the trained first and second predictive models 114 and 118 and their respective first and second parameter values 116 and 120 generated by the above training. The example provides improved accuracy compared with training a single model, especially using a relatively small number of samples such as only using available ink vectors rather than all possible NPac vectors.

Although the blocks of the method 500 of FIG. 5 are shown sequentially it is understood that they may be performed in a different order than that described above. For example, data indicative of the combination of color resources used to render color test patches on a color rendering device may be obtained before data indicative of color characteristics measured from the color test patches.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
obtaining data indicative of color characteristics measured from a number of color test patches;
obtaining data indicative of combinations of color resources used to render the color test patches on a color rendering device;
training a first predictive model using the data indicative of the combinations of color resources as an input and corresponding data indicative of color characteristics as ground truth outputs;
generating output data from the first predictive model; and
training a second predictive model using the output data from the first predictive model as an input and the corresponding data indicative of color characteristics as ground truth outputs,
wherein the first and second predictive models implement a progressive mapping to predict color characteristics rendered by the color rendering device given a combination of color resources.

2. The method of claim 2, wherein the data indicative of the combinations of color resources includes ink-vectors or Neugebauer Primary area coverages.

3. The method of claim 1, wherein the color resources include one or more of inks, substrates, and half-toning functions.

4. The method of claim 1, comprising determining an error between the output data from the second predictive model and the data indicative of color characteristics used as a ground truth and continuing training until the error is below a threshold or no longer reduces.

5. The method of claim 1, wherein the predictive models use polynomial regression mapping and regularization.

6. The method of claim 1, wherein the data indicative of color characteristics comprise one or more of spectral reflectance measurements, tristimulus measurements and colorimetric measurements.

7. The method of claim 1, comprising controlling the color rendering device depending on the predicted color characteristics.

8. The method of claim 1, comprising selecting, according to a secondary metric, from amongst a plurality of combinations of color resources having predicted color characteristics within a range.

9. The method of claim 8, wherein the secondary metric is ink-efficiency.

10. The method of claim 1, comprising segmenting the color test patches and training separate predictive models for respective segments.

11. The method of claim 10, wherein the segmentation is based on lightness of the colors and/or total ink coverage.

12. The method of claim 1, comprising determining a color gamut of the color rendering device using the predicted color characteristics.

13. The method of claim 1, comprising rendering on the color rendering device a number of color test patches using combinations of color resource.

14. A color prediction apparatus comprising:
a first storage medium storing computer program code to implement a progressive mapping comprising first and second predictive models;
a second storage medium storing parameter values for the first and second predictive models, the parameter values being generated by training the first and second predictive models on sets of training samples, a first set of training samples comprising data indicative of combinations of color resources and corresponding measured color characteristics, a second set of training samples comprising color characteristics output by the first predictive model and corresponding measured color characteristics; and
a processor to execute the computer program code of the first storage medium to apply the progressive mapping as parameterized with the parameter values from the second storage medium to predict color characteristics for a color rendered by the color rendering device using an indicated combination of color resources.

15. A non-transitory computer-readable storage medium storing instructions that, when executed by a processor, cause the processor to:
obtain data indicative of color characteristics measured from a number of color test patches;
obtain data indicative of color resources used to render the color test patches on a color rendering device;
train a first predictive model using the data indicative of the combinations of color resources as an input and corresponding data indicative of color characteristics as ground truth outputs;
generate output data from the first predictive model; and
train a second predictive model using the output data from the first predictive model as an input and the corresponding data indicative of color characteristics as ground truth outputs,
wherein the first and second predictive models implement a progressive mapping to predict color characteristics rendered by the color rendering device given a combination of color resources.
